(19) United States
(12) Patent Application Publication
(10) Pub. No.: US 2021/0326353 A1
(43) Pub. Date: Oct. 21, 2021

(54) INCREMENTAL CHANGE AND DEPLOY

(71) Applicant: Unisys Corporation, Blue Bell, PA (US)

(72) Inventors: Jared Poetter, St. Paul, MN (US); Michael C. Leap, Collegeville, PA (US); Robert A. Johnson, Collegeville, PA (US); Philippe Jolly, Rotterdam (NL); Richard W. Phelps, Cary, NC (US); Michael J. Di Domenico, Wayne, PA (US); Diane Schaefer, North Wales, PA (US)

(21) Appl. No.: 16/937,042

(22) Filed: Jul. 23, 2020

Related U.S. Application Data
(60) Provisional application No. 63/011,716, filed on Apr. 17, 2020.

(51) Int. Cl. G06F 16/27; G06F 8/60

(52) U.S. Cl. CPC G06F 16/27; G06Q 10/105; G06F 8/60

(57) ABSTRACT

A method of deploying a solution in a network secured network environment using a network visualization software application is disclosed. The method includes receiving, by a processor, a user selected solution to deploy; queuing, by the processor, the solution to deploy; determining, by the processor, if the user desires to synchronize the solution; if the user desires to synchronize the solution, synchronizing, by the processor, the solution; and if the user does not desire to synchronize the solution, failing, by the processor the solution.

### FIELD OF THE DISCLOSURE

The present application relates generally to tracking incremental changes and deploying those changes in a secure network. The present application also relates to keeping a history of all modifications, including the incremental changes and deployments.

### BACKGROUND

Robust enterprise security software is complex. The complexity of enterprise security software increases with the level of security required. For example, in enterprise networks in which data must be secured during intra-network storage and/or transmission, detailed definitions regarding a level of security for each user, types of encryption, permissions, and other policies must be set. Because there are often a large number of computing systems within such an enterprise network, provisioning each system can become so complex as to be time- and cost-prohibitive to install such enterprise security software, or at the very least to exploit its full capabilities. Network visualization products enable an administrator, or user, to easily configure and deploy network security policies in order to protect a network. A user can easily discover endpoints and communications on the network using a live discovery or existing packet capture files to automatically develop network models. Alternatively, a user can create network models from scratch utilizing network visualization products to design new segments or entire networks. One of the important pieces of managing a complex enterprise network is the IT service management (“ITSM”), or IT infrastructure library (“ITIL”), change control and request process. This process enables organizations and network management teams to coordinate, track, and log all changes that happen in their enterprise network, including those related to the security of it.

In some cases, when a full ITSM process doesn't exist or network visualization products do not cleanly and easily integrate into the process, network administrators have had to resort to piecing these changes together by using screenshots or dumping information directly from a backend database in order to generate reports and capture the current and future states of their network security software.

In some cases, when deploying security changes to a network, the process can consist of generating a datafile, for example in the format of JSON or XML, that contains all of the devices that have been previously deployed, or need to be updated or removed, and copying that datafile over to the enterprise network security management server. From there a set of scripts processes the datafile on the management server to create and provision the objects for each device. This manual process is time consuming, error prone, and has the potential for deploying a configuration that does not match the security network shown in the network visualization software created by the network administrator. Therefore, improvements in the area of change management and deployment are desirable.

### SUMMARY

In a first aspect, a method of tracking changes in a network visualization software application is disclosed. The method includes creating, by a logical processor, a log table corresponding to an object table for an object in the software application; monitoring, by the logical processor, the object for all user actions; determining, by the logical processor if the object has been acted upon by the user; and if the object has been acted upon by the user, then inserting, by the logical processor, a new row in the log table reflecting the action on the object.

In a second aspect, a method of deploying a solution in a secured network environment using a network visualization software application is disclosed. The method includes receiving, by a logical processor, a user selected solution to deploy; queuing, by the logical processor, that solution for deployment; determining, by the logical processor, if the user desires to synchronize the solution; if the user desires to synchronize the solution, synchronizing, by the processor, the solution; and if the user does not desire to synchronize the solution, failing, by the processor the solution.

The foregoing has outlined rather broadly the features, technical advantages, and process of the present invention in an order that the detailed description of this invention may be better understood. Additional features and advantages of the invention described hereinafter form the subject of the claims for the invention. It should be appreciated by those skilled in the art that the conception and specific embodiment disclosed may be readily utilized as a basis for modifying or designing other structures for carrying out the same purposes and intentions of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures are provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating an encrypted enclave of virtual machines organized into communities-of-interest, according to one embodiment of the present invention;

FIG. 2 is a is a block diagram illustrating a network implementing communities-of-interest, according to one embodiment of the present invention;

FIG. 3 is a block diagram illustrating an enclave included in the network of FIG. 2;

FIG. 4 is an illustration of a database schema, according to one example embodiment of the present invention;

FIGS. 5A through 5I are enlarged views of a portion of the database schema of FIG. 4.

FIG. 6 is a schematic diagram of a system for tracking changes, according to one example embodiment of the present invention;

FIG. 7 is a flow diagram of a method of tracking changes, according to one example embodiment of the present invention;

FIG. 8 is a schematic diagram illustrating states of deployments, according to one example embodiment of the present invention;

FIG. 9 is a flow diagram of a method of deploying a solution, according to one example embodiment of the present invention.

FIG. 10 is a block diagram illustrating a computer network, according to one example embodiment of the present invention;

FIG. 11 is a block diagram illustrating a computer system, according to one example embodiment of the present invention;

FIG. 12A is a block diagram illustrating a server hosting an emulated software environment for virtualization, according to one example embodiment of the present invention; and

FIG. 12B is a block diagram illustrating a server hosting an emulated hardware environment, according to one example embodiment of the present invention.

### DETAILED DESCRIPTION

In general, the present disclosure relates to tracking changes, determining any incremental change, deploying those changes, all with support of an ITSM or ITIL process, in a secured network environment. Stealth enterprise security solution from Unisys Corporation of Blue Bell, Pa. can be used to implement features of the present disclosure. Unisys's Stealth Suite includes both Stealth(core) (“Stealth”) and Stealth(aware).

Stealth reduces attack surfaces in a network environment by creating dynamic, identity-driven microsegments called communities-of-interest. Micro segmentation is a security strategy that segments a network into smaller elements and manages them with IT security policies. By establishing secure community-of-interest, Stealth separates trusted devices, users and data from unknown or untrusted devices. It can further reduce attack surfaces by encrypting all communication between Stealth protected devices and cloaking the devices from unauthorized or unknown users. Micro segmentation divides a physical network into multiple logical micro-segments. Only the resources within the micro segment can see and communicate with one another.

For example, virtual or physical machines executing on one or more servers may each be assigned to one or more communities-of-interest. The communities-of-interest may allow an administrator to create logical organizations of virtual machines. A community-of-interest may be defined by a role performed by the virtual machines in the application stack.

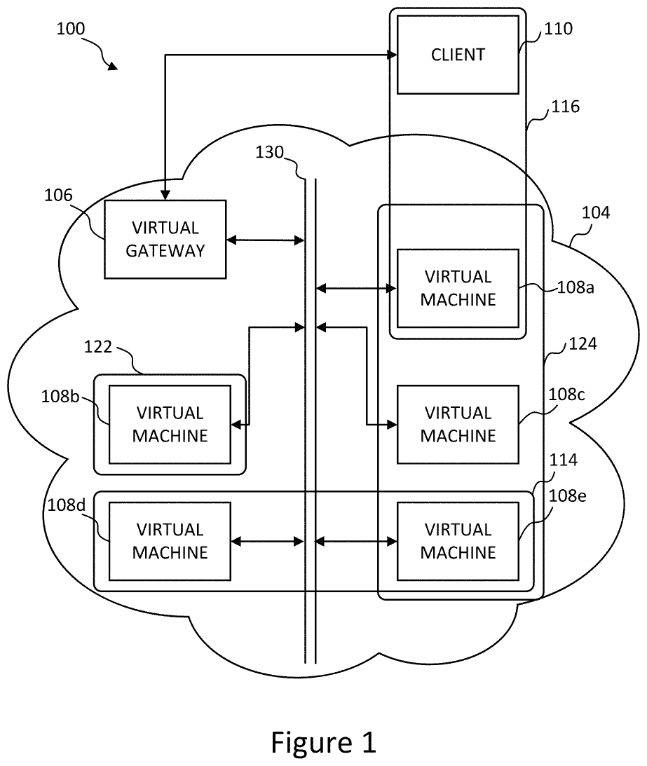

Messages or communications within a community-of-interest are encrypted with a key corresponding to the community-of-interest. In this fashion, messages or communications are cryptographically isolated. FIG. 1 is a block diagram illustrating an encrypted enclave of virtual machines organized into communities-of-interest according to one example embodiment of the present disclosure. A network 100 may include a network bus 130 serving an enclave 104. The bus 130 may couple virtual machines 108a-e within the enclave 104. Each of the virtual machines 108a-e may communicate through encrypted communications carried on the bus 130. A virtual gateway 106 may be coupled to the bus 130 to provide communications from the enclave 104 to external devices, such as a client 110 and/or other public networks, such as the Internet. The client 110 may be a remote device, such as a personal computer or mobile device. The client 110 may be connected to the virtual gateway 106 through a secured tunnel, such that the communications between the client 110 and the virtual gateway 106 are encrypted similar to the encrypted communications on the bus 130.

The virtual machines 108a-e may be assigned to one or more communities-of-interest. For example, the virtual machines 108a, 108c, and 108e may be assigned to community-of-interest 124. Virtual machines 108d and 108e may be assigned to community-of-interest 114. And, virtual machine 108b may be assigned to community-of-interest 122. And, the virtual machine 108a and the client 110 may be assigned community-of-interest 116.

A virtual machine 108e may be instructed to transmit a message, or data, to the virtual machine 108a. For example, software executing on the virtual machine 108e may request data from a database server hosted on the virtual machine 108d. When the virtual machine 108e receives the message destined for the virtual machine 108a, the virtual machine 108e may identify a community-of-interest in common between virtual machine 108e and virtual machine 108a. The community-of-interest 124 may be identified and a key associated with community-of-interest 124 may be used to encrypt the message.

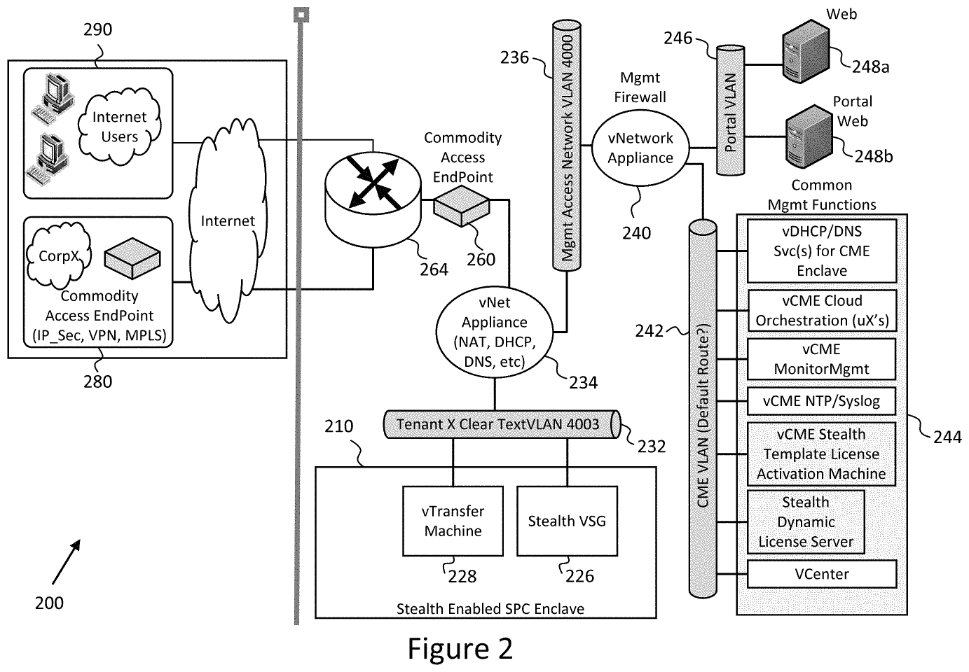

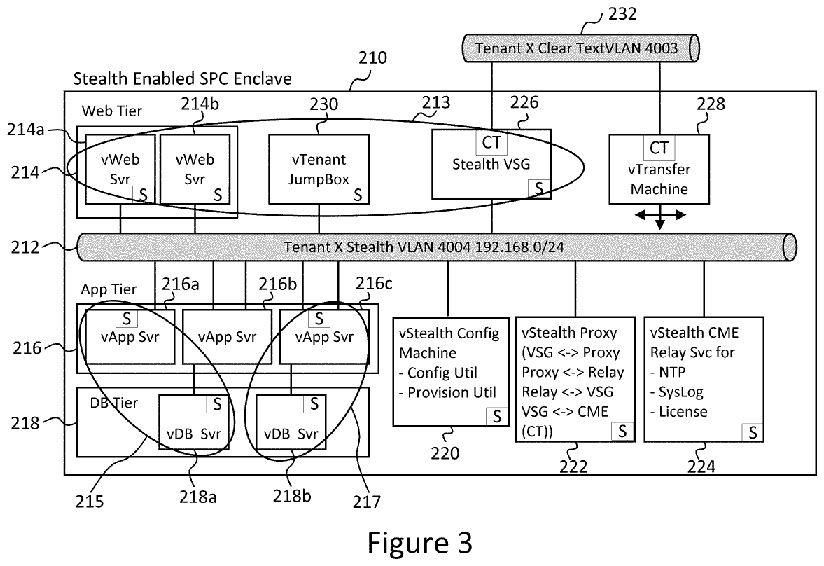

The community-of-interest organization of virtual machines may be implemented in a computer network to provide cryptographic isolation of virtual machines. FIGS. 2 and 3 are block diagrams illustrating a network implementing communities-of-interest according to one embodiment of the disclosure. A network 200 may include an enclave 210. According to one embodiment, the enclave 210 may belong to a single tenant of the network 200. In other embodiments, the enclave 210 may be shared between tenants.

Communities-of-interest may be configured for a web tier 214, an application tier 216, and a database tier 218. The web tier 214 may include a number of web servers 214a-b, the application tier 216 may include a number of application servers 216a-c, and the database tier 218 may include a number of database servers 218a-b. Each of the servers 214a-b, 216a-c, and 218a-b may be a virtual server executing within a virtual machine. Additional communities-of-interest may be defined for infrastructure functions, such as administrative, proxy, application tier management, database tier management, or a jumpbox management. The enclave 210 may also include a jumpbox 230, a transfer machine 228, a virtual gateway 226, a relay 224, a proxy 222, and a configuration device 220, which may also be executing in virtual machines.

Membership of the virtual machines in individual communities-of-interest are shown as numbered circles 213, 215, 217. For example, a community-of-interest 213 may include the servers 214a-b, the jumpbox 230 and virtual gateway 226. According to one embodiment, only virtual machines that share a common community-of-interest may communicate. When the first virtual machine initiates communication with the second virtual machine, the first virtual machine may search for a common community-of-interest between the first and the second virtual machine. If found, a cryptographic session key may be created that is encrypted with a key associated to the common community-of-interest. Thus, only a virtual machine that shares the community-of-interest key may decrypt the session key. All communication between the two virtual machines may be encrypted and decrypted with the session key. Messages within the enclave 210 may be isolated from the rest of the network 200, because the messages are encrypted with keys that are not available to the rest of the network 200.

For example, a web server virtual machine 214a may be able to communicate with another web server virtual machine 214b, because the virtual machines 214a-b have the community-of-interest 213 in common. They cannot communicate with the DB tier since the machines 218a-b do not have a community-of-interest in common with the virtual machines 214a-b.

Each of the devices within the enclave 210 may be coupled to a bus 212. When a device within the enclave 210 communicates with devices outside the enclave 210, then messages may be handled by the virtual gateway 226, which may be coupled to an unencrypted network 232. According to one embodiment, the virtual gateway 226, such as a Stealth Gateway, may encrypt and/or decrypt messages between the enclave 210 and the unencrypted network 232. The network 232 may couple the enclave 210 to other network appliances 234, such as network address translation (NAT) devices, dynamic host control protocol (DHCP) devices, domain name service (DNS) devices, and the like. The other network appliances 234 may also be executing in virtual machines.

Access to the enclave 210 may be controlled by the virtual gateway 226. Messages passing through the gateway 226 from the unencrypted, or clear-text, network 232 to the enclave 210 may be encrypted and messages in the other direction may be decrypted by the gateway 226. According to one embodiment, messages within the enclave 210 may only be transmitted to a virtual machine that has a community-of-interest in common with the gateway 226. Furthermore, the gateway 226 may be configured to filter messages for a community-of-interest. The filter may allow an administrator to restrict access based on a message's source and/or destination address and/or port. The enclave 210 may also be isolated from other enclaves (not shown) in the network 200, because only a virtual machine having a common community-of-interest with the gateway 226 may communicate outside of the enclave 210.

For example, the web servers 214a-b may be able to communicate through the gateway 226, because the web servers 214a-b share the community-of-interest 213 with the gateway 226. In another example, the application servers 216a-c and the database servers 218a-b may have restricted access through the gateway 226, because the gateway 226 may filter messages transmitted in the application community-of-interest and the database community-of-interest to only provide access from management devices 244.

Productivity and innovation require access to IT services on-premises and in the cloud, from any device, in any location globally. Traditional security perimeters are dissolving, increasing the network complexity and making it difficult to keep track of all the activity, especially in regards to security. Stealth(aware) is a network visualization product that enables a user to easily configure and deploy network security policies in order to protect the network. Stealth(aware) allows a user to visually discover endpoints and traffic on the network, as well as communications, using live discovery or existing packet capture files. Additionally, Stealth(aware) enables a user to create new network models from scratch to visualize new environments.

To simplify network complexity, Stealth(aware) automatically groups devices, or Nodes, into Profiles that have similar traffic patterns. Granularity levels are adjusted to balance simplicity and details. With a single click, a network model can be transformed into a model of micro segmentation policies. Stealth(aware) keeps the network view current by refreshing network model to identify policy violations or unwanted and suspicious communications between Nodes. It then allows the network administrator to quickly create and update network security polices to isolate the Node or block the suspicious communication.

One of the important pieces of managing an enterprise network is the ITSM, or ITIL, change request process. Previously, in Stealth(aware) the user was required to manage or track changes that happen to their Project or environment manually. In some cases, users have pieced together screenshots to generate graphical reports and pulled information directly from a backend database in order to capture the current state of their Project, or network model.

The deployment process usually consists of generating an XML file with all of the application stacks, or Solutions, that have been previously deployed or need to be updated or need to be created, and copying that datafile over to the Stealth Enterprise Manager. From there a set of PowerShell scripts process the XML file and create the actual objects that are provisioned to the Stealth endpoints.

A new Stealth(aware) Change History feature enables the application to automatically track every change made to the user's Project. This feature enables the support of a true ITSM, or ITIL, change request process from the backend side of Stealth(aware) and also is the foundation for the application to implement several additional features, such as Undo/Redo and Incremental Change and Deploy. The Change History feature allows users to see how objects, such as Nodes, Profiles, etc., change, what those changes were, who made those changes, and when those changes occurred.

Storing all of the changes made to a Stealth(aware) Project at a database level enables the application to determine what the state of the Solution was at the last deployment, if it has been deployed at all, and quickly determine if any changes have been made in any objects like Profiles, Channels, Flows, etc. since the previous deployment. This can be useful to create a report and, in turn, go through the change request process.

Additionally, knowing what has changed, whether it is moving Profiles between Solutions, or just changing the name of a Channel, enables Stealth(aware) to deploy incremental changes. These changes will only make the smallest requests required to Stealth Enterprise Manager (“EM”) for modifying the production configuration, which leads to minimized downtime for the client.

Another feature is the ability to condense all of the changes between each deployment of a Solution, which results in a reduced database footprint. As soon as a Solution is deployed, the only state needed to be maintained for a user to roll back to a previous deployment is the state of that deployment and none of the incremental changes in between.

An example implementation of this feature can consist of an object table that resides in the Stealth(aware) database and stores and maintains a Project's model objects, such as a Node, Profile, Solution, Channel, Flow, Classification, Property Set, etc. The object tables refer to those objects' corresponding tables in the database (i.e. the node table, the profile table, etc.). In other words, an object table is considered any table that can be affected as the result of a direct user action.

The Change History feature implements a mechanism for versioning each object table by creating log tables based on the current object tables. Each row in these log tables represents the state of an object at a single point in time. Anytime an object is created, modified, or deleted, a new row is inserted into the corresponding log table with a snapshot of the object, a timestamp of when the user action occurred, and whether or not the object was deleted. The current object tables contain the most up-to-date version of each object.

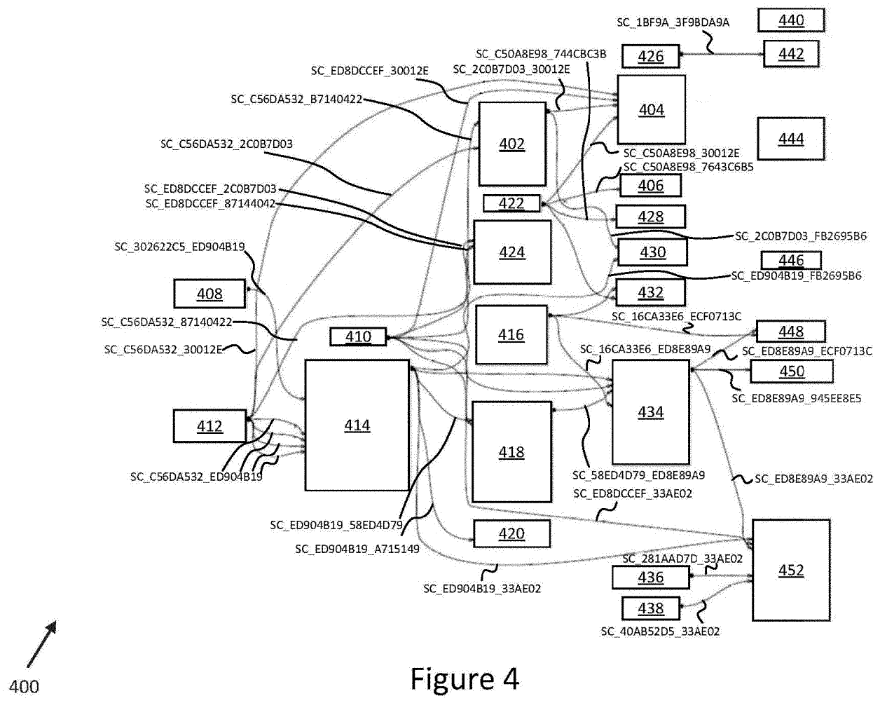

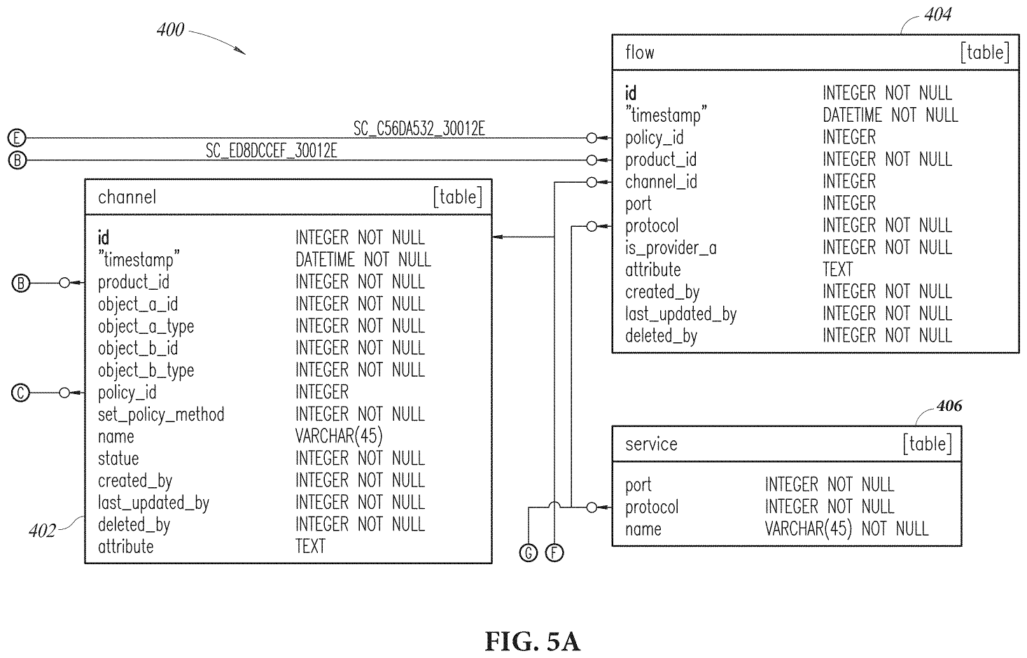

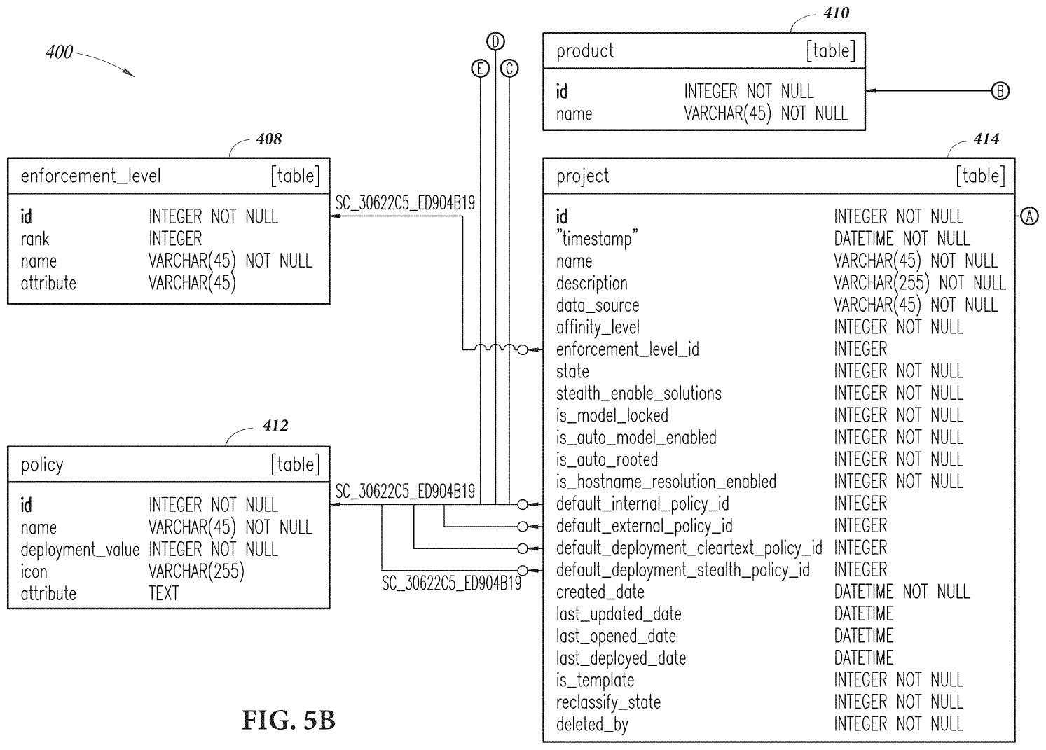

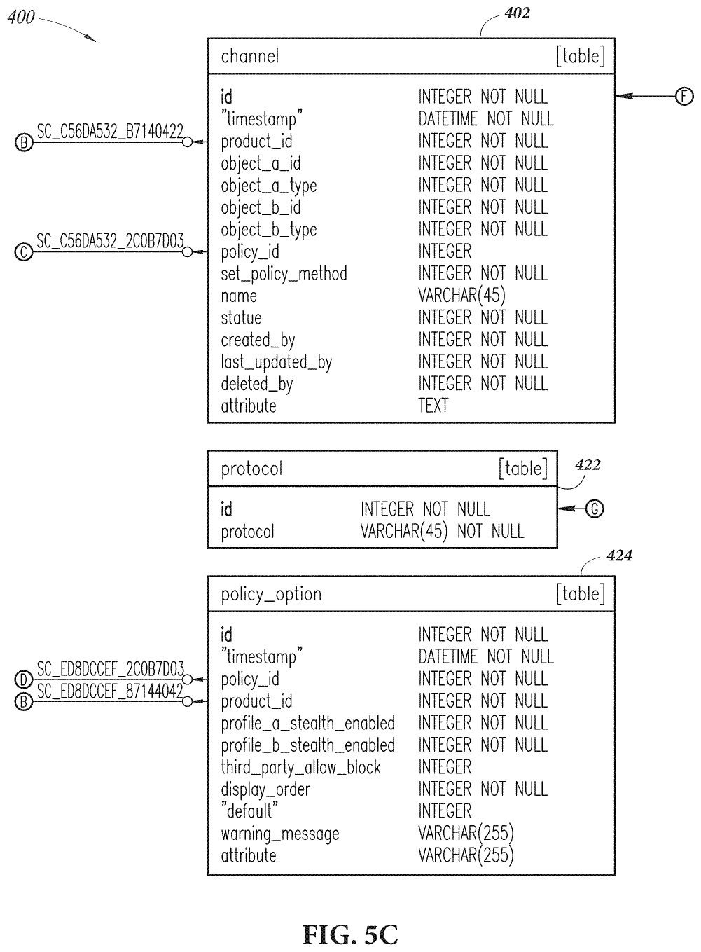

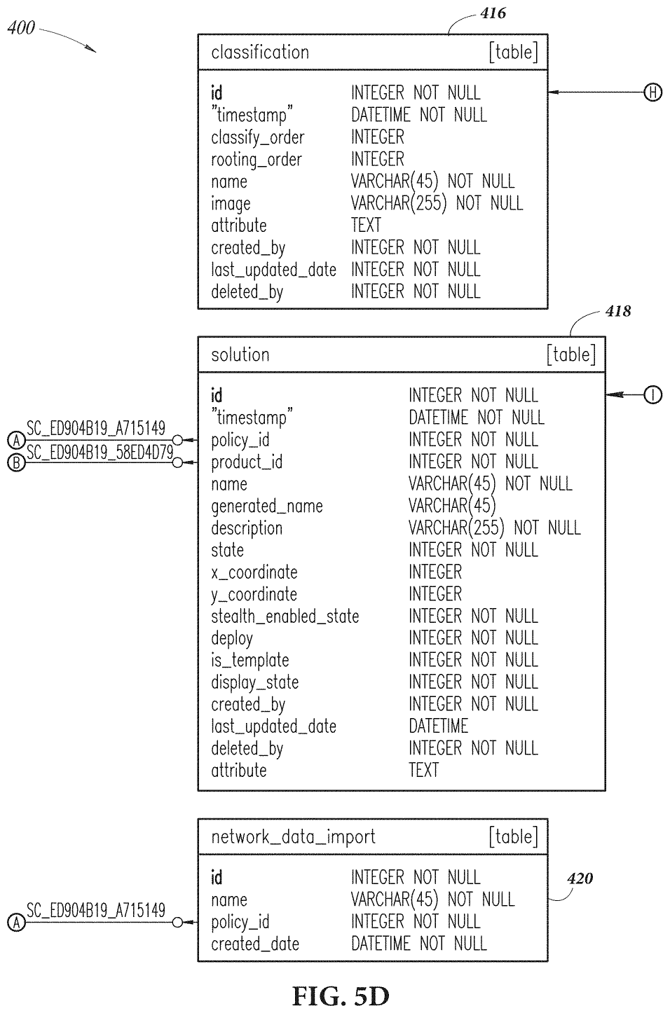

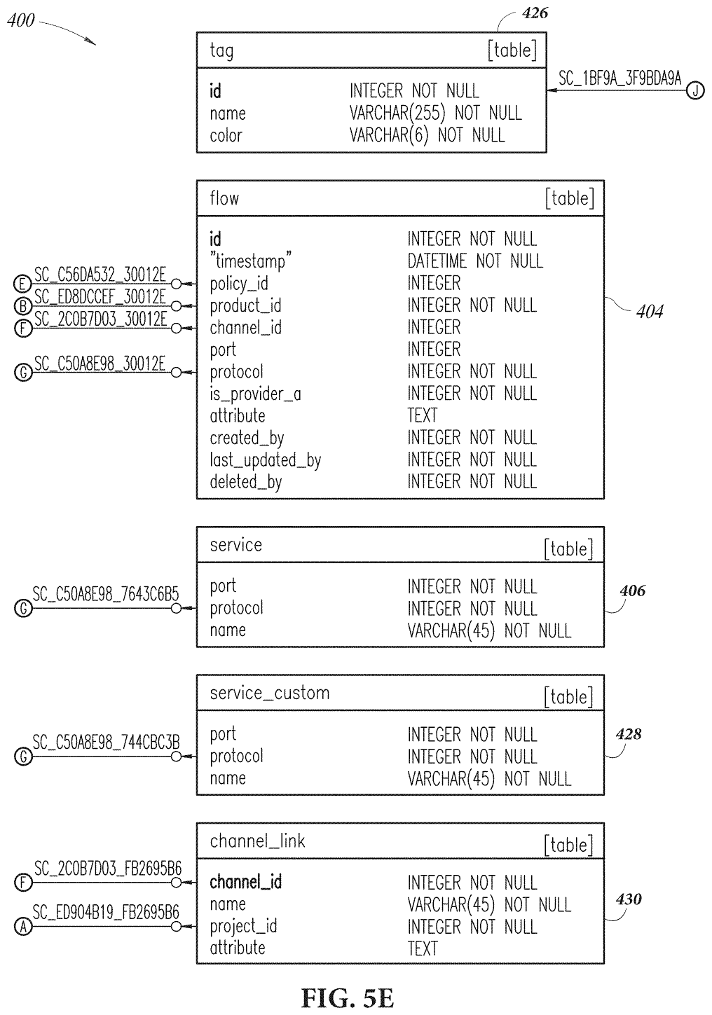

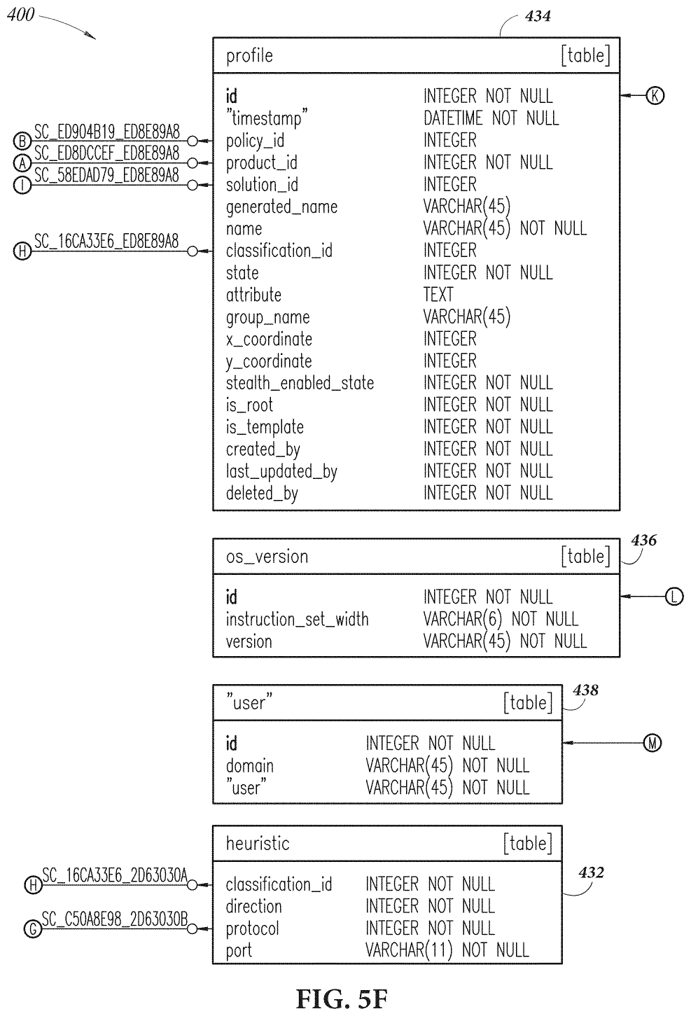

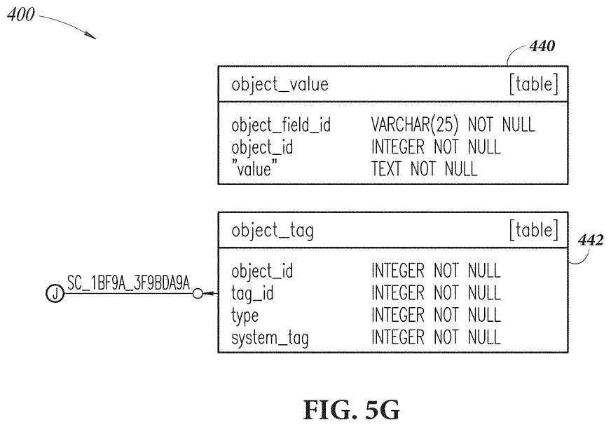

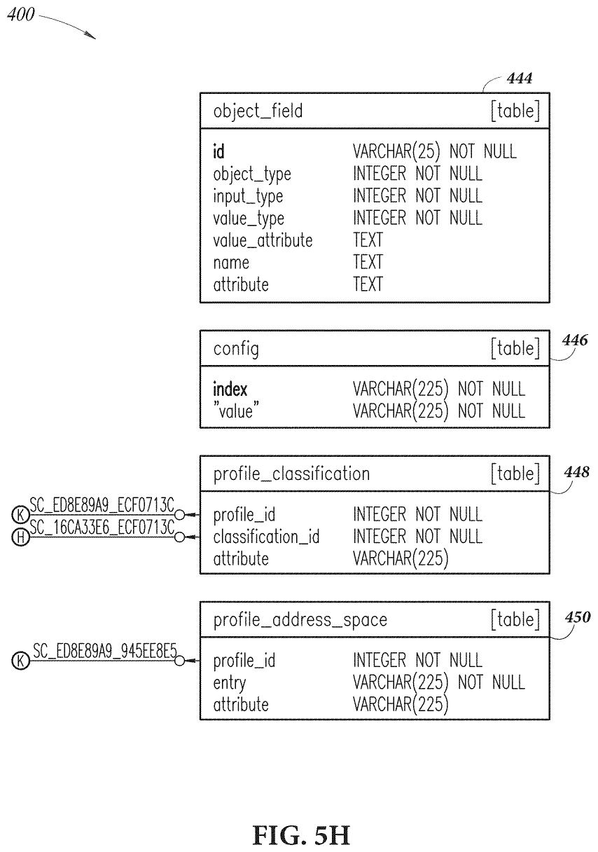

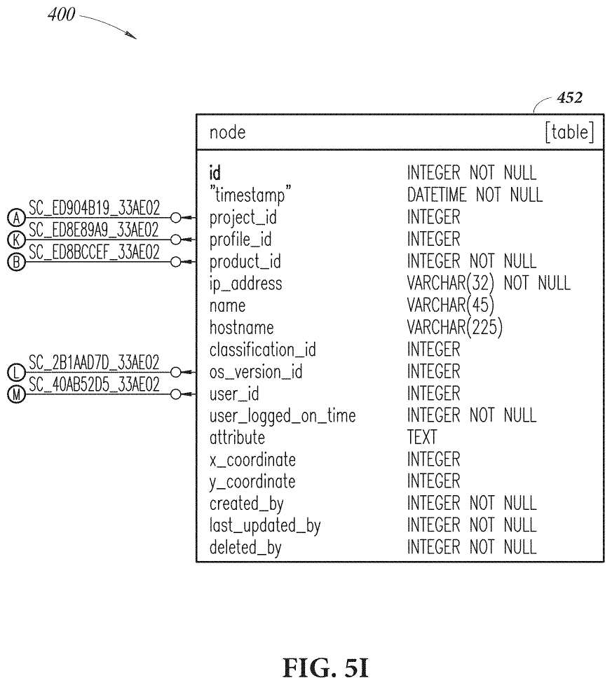

In an alternative embodiment, the change history could be implemented in the object table itself. A single set of object database tables where the object's history is kept along-side the current state, with primary keys being replaced with unique keys that contain the id of the object and a granular timestamp of when the change is made as generally illustrated in the database schema 400 shown in FIG. 4. FIG. 5A_is an enlarged view of the channel table 402 and the flow table 404. As shown in FIG. 4, taking the Channel and Flow object relationship in the channel table 402 and flow table 404, the channel table 402 has a unique key of “id” and “timestamp” and the fields of “created_by”, “last_updated_by”, and “deleted_by”. The flow table 404 also has a unique key of “id” and “timestamp” and the fields of “created_by”, “last_updated_by” and “deleted_by”. In the use case where the network administrator creates a new Channel, for example of “id” set to “1”, an entry is added to the channel table with the unique key of “id” set to “1” and timestamp set to, for example, “2020-04-01 12:23:14”, the name field set to “My Channel”, and the “created_by” field is set to “1”. When the network administrator updates the Channel, for example changing the name from “My Channel” to “Another Channel”, a new entry is added to the channel database table with the “id” set to “1” and the timestamp set to, for example, “2020-04-02 08:55:23”, the “name” field set to “Another Channel”, and the “last_updated_by” field set to “1”.

If this information is displayed in the network visualization tool, the database query would do a select similar to “SELECT*FROM channel WHERE id=1 ORDER BY timestamp DESC LIMIT 0,1”, to get the latest state of the Channel object from the database. In the case of displaying a Flow that is a member of a Channel, assuming there is an entry in the flow table 404 that references Channel id of “1”, the network visualization tool will return the latest information, or record, from the flow table 404 based on the “channel_id” field set to “1” ordered by timestamp descending. In the use case where the user has deleted the Channel of id equal to “1”, the network visualization tool would follow the same approach to pull the information from the flow table 404 where the “channel_id” field is “1” and the resulting query is limited to the most recent entry based on the “timestamp” field of the flow table 404. The network visualization software will then check the attributes of the channel table 402 entry to make sure that the “deleted_by” field is set to null. If the field is set to a non-null value that means the Channel has been removed and that Channel and child Flows should not be displayed to the network administrator.

In the case where a Channel has been removed, the removal of the record for the database can happen after the parent Solution has been deployed to Enterprise Manager as part of the process when the incremental changes are condensed down to save database space and so that rollback ability is maintained. FIG. 4 includes additional tables 406-452 that provide additional detail. FIGS. 5A through 5I are enlarged views of tables 402-452 of FIG. 4.

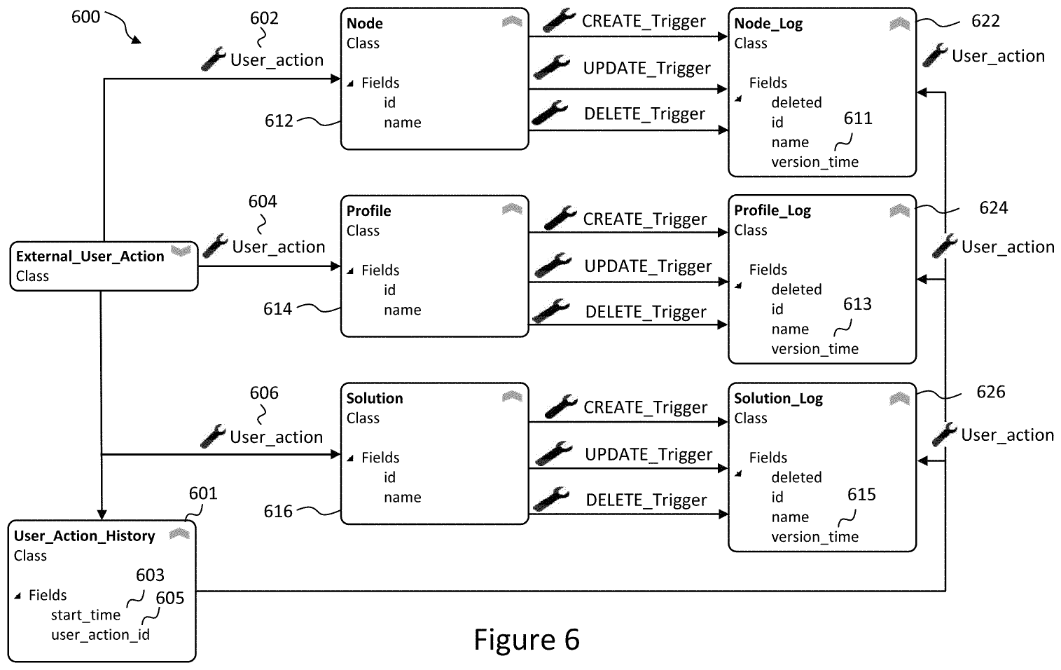

FIG. 6 is a schematic of a system 600 for tracking changes. The system 600 includes a user action history 601 having a start_time 603 and a user_action_id 605. The system 600 also includes user actions 602, 604, 606; object tables 612, 614, 616; and log tables 622, 624, 626. Object versions in each log table are based off of timestamps. Whenever a user executes a new action 602, 604, 606 that affects model objections 612, 614, 616, Stealth(aware) inserts a new row into the user_action_history table 601 with the start_time 603 of when the action began. Additionally, a new record for each object 612, 614, 616 that was affected by the user action 602, 604, 606 respectively will be inserted into their corresponding log tables 622, 624, 626, respectively with a timestamp (“version_time”) 611, 613, 615 that matches the “start_time” of the user action that caused these objects to be affected. In order to figure out which user action caused an object to change, Stealth(aware) retrieves the version_time from the log table of the object in question, and matches that to a start_time in the user_action_history table.

A user_action table is a read only table that defines the list of actions a user can take that cause creation, deletion or modification of a Project's model (specifically, model objects). Whenever new user actions are added to Stealth(aware) that require Change History functionality, this table is updated to reflect the new action available. The user_action_history table is a log of the user's actions as they are taken. An entry to this table consists of two parts: a start_time, which indicates when the action occurs, and a user_action_id, which corresponds to an action within the user_action table.

The current state of the model can be viewed by querying the current object tables. To determine the state of a model at a particular point in time, the user_action_history table is queried for the start_time of the user action at the point in time the user wants to see the state of the model. All of the object log tables can be queried for the record of each object with the most recent version_time that is less than or equal to the start_time. To determine differences between two versions of the model, the user_action_history table can be queried for the two start_time(s) of the user actions to compare. The object log tables can be queried for the record of each object with the most recent version_time that is less than or equal to the first start_time. All of the object log tables are queried for the record of each object with the most recent version_time that is less than or equal to the second start_time. Comparison of the two states for every object determines the changes that have been made between the two versions.

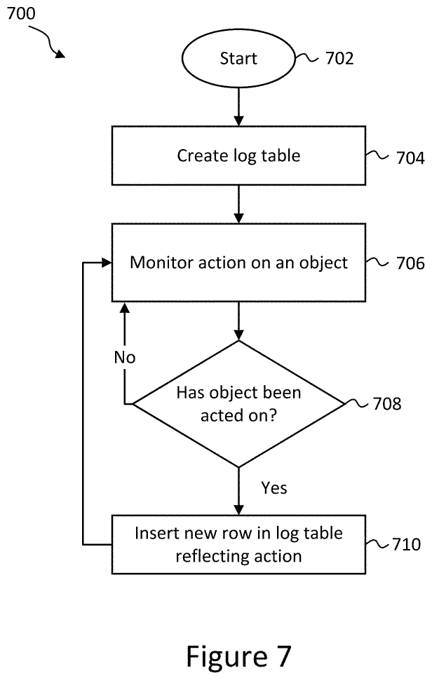

FIG. 7 is a flow diagram of a method 700 of tracking changes. The method starts at 702. At 704, the system creates a log table based on a current object table. Creating a log table is done only at initial start of an application and not every time the application is started. Each row in the log table represents the state of an object at a single point in time. At 706, the system monitors the object for any action on the object, such as a creation, modification or deletion. At 708, the system determines if the object has been acted on. If the system determines the object has not been acted on, flow reverts to monitoring at 706. If the system determines the object has been acted on, the system inserts a new row in the log table reflecting the action at 710. Flow reverts back to monitoring at 706.

A Stealth(aware) Incremental Change and Deploy feature provides the configuration, automation, and support for Stealth(aware) to automatically configure all parts of the EM, in addition to being able to deploy a small change all the way from Stealth(aware) to the Endpoint of Stealth, causing the least disruption to the network.

In Stealth(aware), when a Project is initially created, a set of predefined Solutions, Profiles, Channels and Flows are automatically created for the user to help with the initial set up of a Stealth Environment. As part of creating these pre-defined objects, a Stealth recommended configuration is provided for the user in order to have a functioning Stealth environment as quickly as possible. This set of pre-defined objects are referred to as part of the Tier 0 services.

The Incremental Change and Deploy feature enables the application to handle a lot of the tracking and reduce the human error that is possible when you are trying to create, review and apply a set of changes to the Stealth network. Stealth(aware) will handle creating all of the necessary components needed for an ITSM review process and also create ITSM review tickets all with Stealth(aware), so users can easily integrate it into their already established process. The set of changes is maintained in Stealth(aware) as to prevent bad actors from tampering with the data integrity that will end up being deployed to the Stealth network.

Stealth(aware) has implemented algorithms, based on the Change History feature, that determine the smallest set of commands needed to execute to apply the changes to the client's Stealth network. This will limit the impact to the already running Stealth environment, that way the user is only required to do a rekey, which will interrupt the network connection of every device, of the smallest number of Nodes that need the latest changes.

Part of the algorithms implemented by Stealth(aware) include the analysis of the entire Project, verifying the changes to be deployed against a set of rules that detect and require all interdependencies between Solutions in a Project are included in a given deployment. For example, if the user is adding a new Channel between two Solutions, Stealth(aware) will require the user to deploy both Solutions, otherwise the new Channel will not be provisioned properly in the Stealth environment and will not match the model built by, model changes approved as part of the ITSM process, and finally deployed by Stealth(aware).

Another feature of Incremental Change and Deploy is the ability to compare two older deployments and see what was changed between them. This will help with debugging issues within the Stealth network and also figure out what has changed since a previous deployment.

The feature can also enable the user to schedule a time at which they want the changes to be applied to the network, for example during a maintenance window occurring at night on a weekend. Stealth(aware) will run all of the configuration commands to call Stealth APIs in order to apply the changes. It will also keep track of the progress to make sure everything completes successfully. While the deployment is executing, if there is any interruption with the network connection to Stealth, the deployment is restarted from the last successful deployment step and continues from there.

This feature also enables the network administrator to have the ability to rollback a deployment if need be to the previous deployment. For example, the user determines a mistake has been made and desires to undo the new deployment.

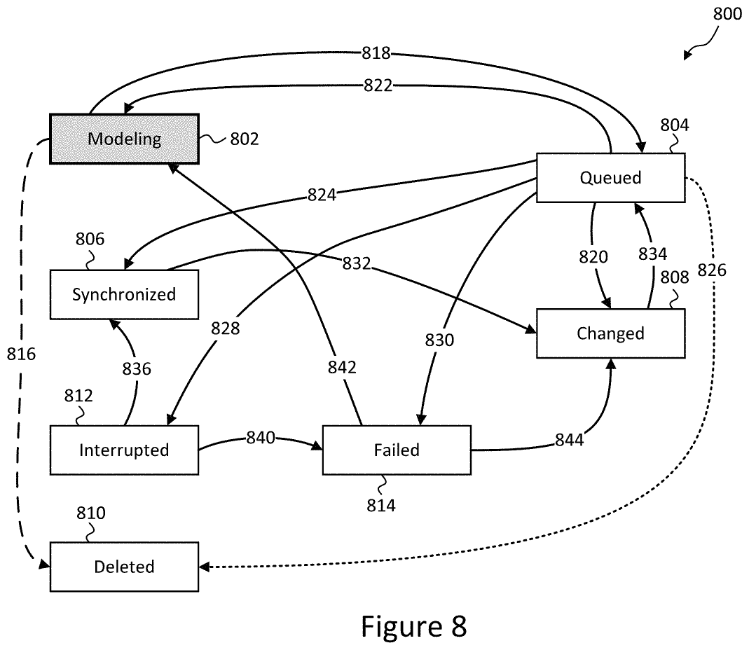

As part of the Incremental Change and Deploy, there are different stages of deployment that a user goes through to make a change live on the network/environment. These states are shown in FIG. 8. The state system 800 includes a Modeling state 802, a Queued state 804, a Synchronized state 806, a Changed state 808, an Interrupted state 812, a Failed state 814 and a Deleted state 810. The Modeling state 802 is the first state when creating a Solution in a Project. In this state, the user is able to add and remove user created Profiles, Nodes and Channels. If the user deletes the Solution, the Deleted state 810 is reached via 816. If the user deploys the Solution, the Queued state 804 is reached via 818. The user sends the deployment ticket information to their ITSM or Change Management tool for the first time for a Solution.

The Queued state 804 represents that changes have been queued for review by a ITSM or Change Management tool. From the Queued state 804, the Changed state 808 can be reached via 820. To reach the Changed state 808, the configuration change was declined by the ITSM or Change Management tool or the user is editing the Queued Solution. The user can only make changes to the Queued Solution if it has already been Synchronized with the Stealth Network at least once. From the Queued state 804, the Modeling state 802 can be reached via 822, when the configuration change is cancelled and the change was previously in the Modeling state 802.

From the Queued state 804, the Synchronized state 806 can be reached via 824 when the configuration change was accepted by the ITSM or Change Management tool and the changes have been pushed to EM. Going to the Synchronized state 806 does not mean the changes have been pushed to the endpoints/Nodes. It just means that the changes have been made to the Enterprise Manage and Authorization Servers.

From the Queued state 804, the Deleted state 810 can be reached via 826 if the user was queuing the Solution to be deleted off the Stealth network. Deleting a Solution still needs to go through the deployment process and get approved by the ITSM process. From the Queued state 804, the Interrupted state 812 can be reached via 828 when there is an interruption in the synchronization, for example if Stealth(aware) has a network connection failure. From the Queued state 804, the Failed state 814 can be reached via 830 when there is a failure with an ecosystem application programming interface (“EcoAPI”) request, for example an incorrect username or password for the EcoAPI.

The Synchronized state 806 represents the Solutions that the EM has distributed the policies (Roles, COIs, Filters, etc.) to Stand-alone Authorization Servers and they are available for endpoints to be authorized with them. This does not represent that the Solution is provisioned. The Change state 808 can be reached via 832 when there are changes made to the synced Solution. Changes can include adding, deleting or modifying Nodes, Flows, Profiles or Solutions. Changes can also include adding, deleting and modifying Property Sets and Authorization Groups.

The Changed state 808 represents Solutions that have been modified since they were last Synchronized. From the Changed state 808, the Queued state 804 can be reached via 834 when the user deploys the Solution changes to the ITSM or Change Management tool. The Deleted state 810 represents the Solutions that have been removed/de-synced from the network. The Solutions are removed from the canvas when they get to this state. All Solutions that have been Synchronized at least once will need to go through the ITSM review process and get approved before the Solution can be deleted. The Profiles and Channels will be removed from the Stealth network but they will be available on the Stealth(aware) canvas for the user to act on if desired.

The Interrupted state 812 represents the Solutions that have been interrupted, for example Stealth(aware) crashes during Synchronization. From the Interrupted state 812, the Synchronized state 806 can be reached via 836, when the user retries synchronization of the changes to the Stealth network and it successfully completed. The Failed state 814 can also be reached via 840 when the user tries to retry to synchronize and it runs into a failure. From the Failed state, the Modeling state 802 can be reached via 842 if the Solution was previously in the Modeling state 802. The user can get to this state after accepting the error message. The Changed state 808 can be reached via 844 if the Solution was previously in the Changed state 808. The user can get to this state after accepting the error message.

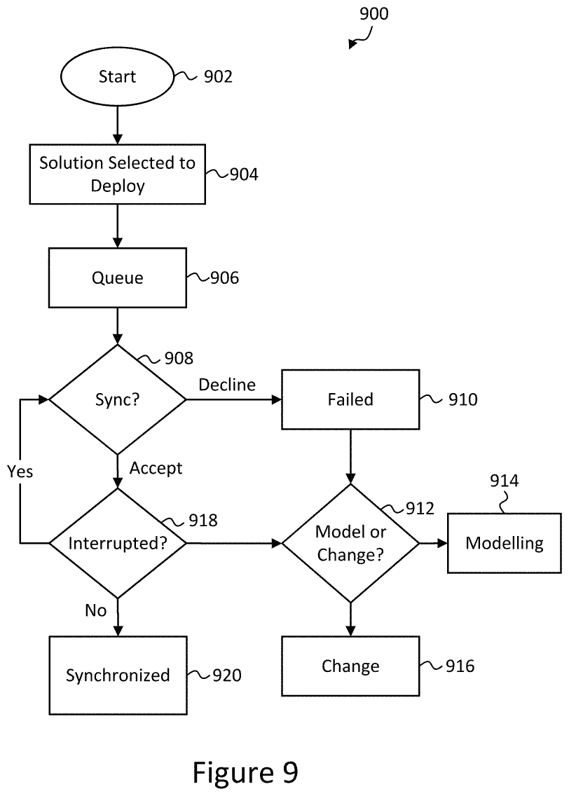

FIG. 9 is a flow diagram of a method 900 of deploying a Solution. The method starts at 902. At 904, a user modified Solution is selected to deploy. A user selects a Solution to deploy and picks the times to schedule provisioning of the Solution and Property Sets. Stealth(aware) generates 2 files. The first file include a deployment ID, a description, a user readable report of the changes and a Hash of the second file. The second file includes a JavaScript Object Notation (“JSON”) blob of the changes in an EcoAPI friendly format (advance). The user creates a ticket in their ITSM/CAB tool and Stealth(aware) generates the files. Once the ticket is created, the user enters in the ITSM/CAB ticket ID into the deployment ticket creation process. At 906, the Solution is Queued. The user waits for the review process to come back with a response of accept or decline synchronization at 908. If the user selects decline, the Stealth(aware) ticket is labeled as Failed 910. At 912, the method 900 determines if the Solution was deployed from the Model state 914 or Change state 916.

Referring back to 908, if the user clicks accept, progress is tracked and shown in Stealth(aware). At 918, the method 900 determines if the synchronization was interrupted. If the synchronization was interrupted, flow returns to 908. If the synchronization was not interrupted, the Solution is synchronized at 920. Once synchronization is complete, the canvas reflects it and the user is presented with information how to execute the Provisioning of the changes to the network. The Stealth endpoints now have the same configuration as shown on the canvas.

Each deployment will have a unique ID that allows history of deployments to be tracked. Previous deployments are visible in the deployment history manager. The state of the deployments can also be tracked.

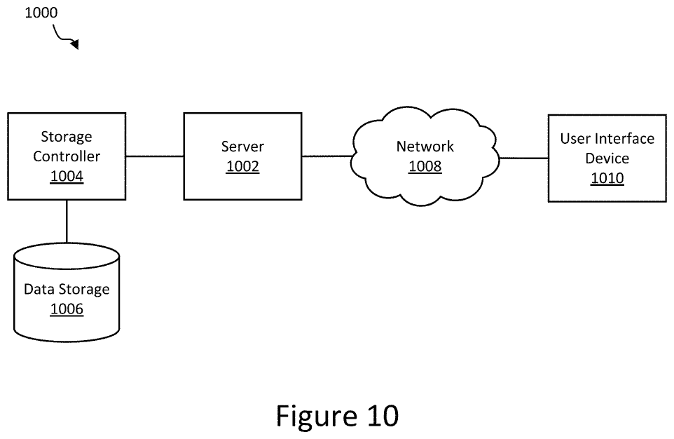

FIG. 10 illustrates one embodiment of a system 1000 for an information system, which may host virtual machines. The system 1000 may include a server 1002, a data storage device 1006, a network 1008, and a user interface device 1010. The server 1002 may be a dedicated server or one server in a cloud computing system. The server 1002 may also be a hypervisor-based system executing one or more guest partitions. The user interface device 1010 may be, for example, a mobile device operated by a tenant administrator. In a further embodiment, the system 1000 may include a storage controller 1004, or storage server configured to manage data communications between the data storage device 1006 and the server 1002 or other components in communication with the network 1008. In an alternative embodiment, the storage controller 1004 may be coupled to the network 1008.

In one embodiment, the user interface device 1010 is referred to broadly and is intended to encompass a suitable processor-based device such as a desktop computer, a laptop computer, a personal digital assistant (PDA) or tablet computer, a smartphone or other a mobile communication device having access to the network 1008. The user interface device 1010 may be used to access a web service executing on the server 1002. When the device 1010 is a mobile device, sensors (not shown), such as a camera or accelerometer, may be embedded in the device 1010. When the device 1010 is a desk-top computer the sensors may be embedded in an attachment (not shown) to the device 1010. In a further embodiment, the user interface device 1010 may access the Internet or other wide area or local area network to access a web application or web service hosted by the server 1002 and provide a user interface for enabling a user to enter or receive information.

The network 1008 may facilitate communications of data, such as dynamic license request messages, between the server 1002 and the user interface device 1010. The network 1008 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 1010 accesses the server 1002 through an intermediate sever (not shown). For example, in a cloud application the user interface device 1010 may access an application server. The application server may fulfill requests from the user interface device 1010 by accessing a database management system (DBMS). In this embodiment, the user interface device 1010 may be a computer or phone executing a Java application making requests to a JBOSS server executing on a Linux server, which fulfills the requests by accessing a relational database management system (RDMS) on a mainframe server.

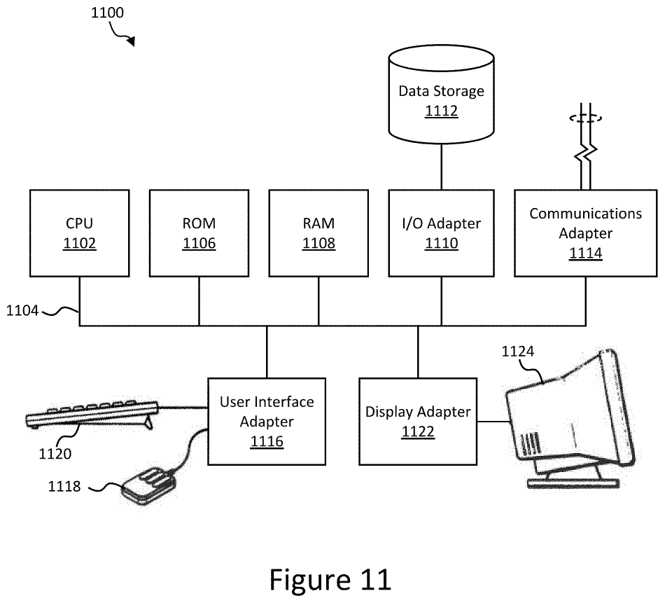

FIG. 11 illustrates a computer system 1100 adapted according to certain embodiments of the server 1002 and/or the user interface device 1010. The central processing unit (“CPU”) 1102 is coupled to the system bus 1104. The CPU 1102 may be a general purpose CPU or microprocessor, graphics processing unit (“GPU”), and/or microcontroller. The present embodiments are not restricted by the architecture of the CPU 1102 so long as the CPU 1102, whether directly or indirectly, supports the operations as described herein. The CPU 1102 may execute the various logical instructions according to the present embodiments.

The computer system 1100 also may include random access memory (RAM) 1108, which may be synchronous RAM (SRAM), dynamic RAM (DRAM), synchronous dynamic RAM (SDRAM), or the like. The computer system 1100 may utilize RAM 1108 to store the various data structures used by a software application. The computer system 1100 may also include read only memory (ROM) 1106 which may be PROM, EPROM, EEPROM, optical storage, or the like. The ROM may store configuration information for booting the computer system 1100. The RAM 1108 and the ROM 1106 hold user and system data, and both the RAM 1108 and the ROM 1106 may be randomly accessed.

The computer system 1100 may also include an input/output (I/O) adapter 1110, a communications adapter 1114, a user interface adapter 1116, and a display adapter 1122. The I/O adapter 1110 and/or the user interface adapter 1116 may, in certain embodiments, enable a user to interact with the computer system 1100. In a further embodiment, the display adapter 1122 may display a graphical user interface (GUI) associated with a software or web-based application on a display device 1124, such as a monitor or touch screen.

The I/O adapter 1110 may couple one or more storage devices 1112, such as one or more of a hard drive, a solid state storage device, a flash drive, a compact disc (CD) drive, a floppy disk drive, and a tape drive, to the computer system 1100. According to one embodiment, the data storage 1112 may be a separate server coupled to the computer system 1100 through a network connection to the I/O adapter 1110. The communications adapter 1114 may be adapted to couple the computer system 1100 to the network 1008, which may be one or more of a LAN, WAN, and/or the Internet. The communications adapter 1114 may also be adapted to couple the computer system 1100 to other networks such as a global positioning system (GPS) or a Bluetooth network. The user interface adapter 1116 couples user input devices, such as a keyboard 1120, a pointing device 1118, and/or a touch screen (not shown) to the computer system 1100. The keyboard 1120 may be an on-screen keyboard displayed on a touch panel. Additional devices (not shown) such as a camera, microphone, video camera, accelerometer, compass, and or gyroscope may be coupled to the user interface adapter 1116. The display adapter 1122 may be driven by the CPU 1102 to control the display on the display device 1124. Any of the devices 1102-1122 may be physical and/or logical.

The applications of the present disclosure are not limited to the architecture of computer system 1100. Rather the computer system 1100 is provided as an example of one type of computing device that may be adapted to perform the functions of a server 1002 and/or the user interface device 1010. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1100 may be virtualized for access by multiple users and/or applications.

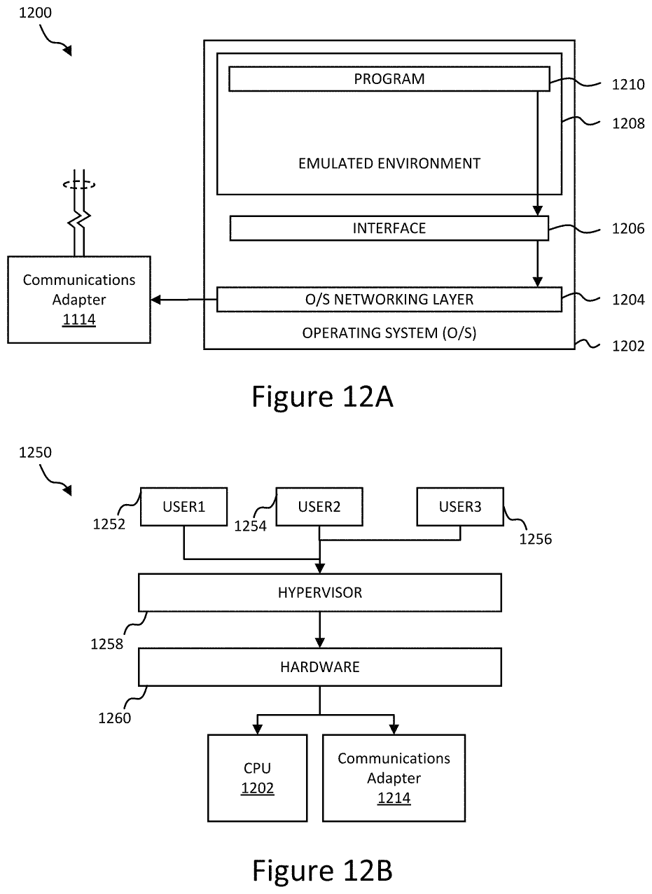

FIG. 12A is a block diagram illustrating a server hosting an emulated software environment for virtualization according to one embodiment of the disclosure. An operating system 1202 executing on a server includes drivers for accessing hardware components, such as a networking layer 1204 for accessing the communications adapter 1114. The operating system 1202 may be, for example, Linux. An emulated environment 1208 in the operating system 1202 executes a program 1210, such as CPCommOS. The program 1210 accesses the networking layer 1204 of the operating system 1202 through a non-emulated interface 1206, such as XNIOP. The non-emulated interface 1206 translates requests from the program 1210 executing in the emulated environment 1208 for the networking layer 1204 of the operating system 1202.

In another example, hardware in a computer system may be virtualized through a hypervisor. FIG. 12B is a block diagram illustrating a server hosting an emulated hardware environment according to one embodiment of the disclosure. Users 1252, 1254, 1256 may access the hardware 1260 through a hypervisor 1258. The hypervisor 1258 may be integrated with the hardware 1260 to provide virtualization of the hardware 1260 without an operating system, such as in the configuration illustrated in FIG. 12A. The hypervisor 1258 may provide access to the hardware 1260, including the CPU 1102 and the communications adaptor 1114.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computer implemented method of deploying a solution in a secured network environment using a network visualization software application, the method comprising:
determining, by a processor, a state of a solution as modeling, queued, synchronized, changed, interrupted, failed or deleted.

2. The method of claim 1 further comprising if a user selects a solution to deploy, changing, by the processor, the state to queued.

3. The method of claim 2, further comprising:
determining, by the processor, if the user desires to synchronize the solution; and
if the user desires to synchronize the solution, synchronizing, by the processor, the solution.

4. The method of claim 3, further comprising after determining if the user desires, determining, by the processor, if the solution can be synchronized and if the user desires and the solution can be synchronized, synchronizing, by the processor, the solution.

5. The method of claim 4, wherein determining if the solution includes determining if the solution can be synchronized by looking to approval from an ITSM process.

6. The method of claim 4, further comprising determining, by the processor, any interdependencies needed to synchronize the solution.

7. The method of claim 1, further comprising if the user does not desire to synchronize the solution, failing, by the processor, the solution.

8. The method of claim 1, further comprising determining, by the processor, if the synchronization was interrupted.

9. A computer implemented method of deploying a solution in a secured network environment using a network visualization software application, the method comprising:
receiving, by a processor, a user selected solution to deploy;
queuing, by the processor, the solution to deploy;
determining, by the processor, if the user desires to synchronize the solution;
if the user desires to synchronize the solution, synchronizing, by the processor, the solution; and
if the user does not desire to synchronize the solution, failing, by the processor the solution.

10. The method of claim 9, further comprising after determining if the user desires, determining, by the processor, if the solution can be synchronized if the user desires and the solution can be synchronized, synchronizing, by the processor, the solution.

11. The method of claim 10, wherein determining if the solution includes determining if the solution can be synchronized by looking to approval from an ITSM process.

12. The method of claim 10, further comprising determining, by the processor, any interdependencies needed to synchronize the solution.

13. A computer program product for deploying a solution in a network visualization software application, comprising:
a non-transitory computer-readable medium comprising a set of instructions that when executed by a programmable computing device causes the computing device to implement a method for configuring a set of network devices, the method comprising:
determining, by a processor, a state of a solution as modeling, queued, synchronized, changed, interrupted, failed or deleted.

14. The computer program product of claim 13 further comprising if a user selects a solution to deploy, changing, by the processor, the state to queued.

15. The computer program product of claim 14, further comprising:
determining, by the processor, if the user desires to synchronize the solution; and
if the user desires to synchronize the solution, synchronizing, by the processor, the solution.

16. The computer program product of claim 15, further comprising after determining if the user desires, determining, by the processor, if the solution can be synchronized if the user desires and the solution can be synchronized, synchronizing, by the processor, the solution.

17. The computer program product of claim 16, wherein determining if the solution includes determining if the solution can be synchronized by looking to approval from an ITSM process.

18. The computer program product of claim 16, further comprising determining, by the processor, any interdependencies needed to synchronize the solution.

19. The computer program product of claim 13, further comprising if the user does not desire to synchronize the solution, failing, by the processor, the solution.

20. The computer program product of claim 13, further comprising determining, by the processor, if the synchronization was interrupted.
